(19) United States
(12) Patent Application Publication
(10) Pub. No.: US 2004/0223188 A1
(43) Pub. Date: Nov. 11, 2004

(54) Printing control method and apparatus

(75) Inventor: Masanari Toda, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/834,038

(22) Filed: Apr. 29, 2004

(30) Foreign Application Priority Data
May 9, 2003 (JP) 2003-132151

(51) Int. Cl. H04N 1/50; H04N 1/56; G06F 3/12

(52) U.S. Cl. 358/2.1; 358/1.13; 358/1.16; 358/3.24

(57) ABSTRACT

A rendering object is spooled as intermediate data for each page, and the color processing mode of each page is determined on the basis of the color attribute of each page of the rendering object. The color processing mode of a page whose color processing mode is not certain is determined on the basis of whether or not the spooled intermediate data contains color data. Print data generated from the intermediate data on the basis of the determined color processing mode is transferred to a printer.

### FIELD OF THE INVENTION

The present invention relates to a printing control method and apparatus of outputting print data to a printing apparatus to print.

### BACKGROUND OF THE INVENTION

Color/monochrome determination in a printing system is disclosed in Japanese Patent Laid-Open No. 10-285421, and is a technique which has already been available as a product. The main purpose of conventional color/monochrome determination is to operate a printer engine as fast as possible. In general, a drawing object whose color/monochrome determination takes a long time, such as BPP (Bit Per Pixel) image data in which each of R, G, and B data is formed by 24 bits, is simply determined to be “color” without actually determining whether the object is color or monochrome.

According to the above-described conventional determination method, when a user creates and prints image data using a monochrome 24-BPP (image of pixels each expressed by 24 bits) image, the image data is determined to be color without checking its contents of the image data, even if the image data is monochrome. If a printing system which charges a user in accordance with the number of color print adopts the above described determination method, the printing cost for color printing is charged though the color printing was not actually performed.

### SUMMARY OF THE INVENTION

The present invention has been made in consideration of the above situation, and has as its feature to provide a printing control method and apparatus capable of color/monochrome determination at high speed and high precision.

According to one aspect of the present invention, there is provided with a printing control apparatus comprising, spool means for spooling a rendering object as intermediate data for each page; first color processing mode determination means for determining a color processing mode of each page on the basis of a color attribute of each page of the rendering object; second color processing mode determination means for determining, on the basis of whether or not the intermediate data spooled in the spool means contains color data, the color processing mode of a page whose color processing mode cannot be determined by the first color processing mode determination means; and transfer means for transferring, to a printing apparatus, print data which is generated from the intermediate data on the basis of the color processing mode determined by the first and/or second color processing mode determination means.

According to one aspect of the present invention, there is provided with a printing control method comprising, a spool step of spooling a rendering object as intermediate data for each page; a first color processing mode determination step of determining a color processing mode of each page on the basis of a color attribute of the page of the rendering object; a second color processing mode determination step of determining, on the basis of whether or not the intermediate data spooled in the spool step contains color data, the color processing mode of a page whose color processing mode cannot be determined in the first color processing mode determination step; and a transfer step of transferring, to a printing apparatus, print data which is generated from the intermediate data on the basis of the color processing mode determined in the first and/or second color processing mode determination step.

Other features and advantages of the present invention will be apparent from the following descriptions taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the descriptions, serve to explain the principle of the invention.

FIG. 1 depicts a view showing a printing system according to an embodiment of the present invention;

FIG. 2 is a block diagram showing the arrangement of the printing system according to the embodiment of the present invention;

FIG. 3 depicts a view showing the memory map of the RAM of an information processing apparatus according to the embodiment of the present invention;

FIG. 4 is a block diagram for explaining a software configuration in the printing system according to the embodiment of the present invention;

FIG. 5 is a block diagram for explaining another software configuration in the printing system according to the embodiment of the present invention;

FIG. 6 depicts a sectional view for explaining the structure of the mechanism of a printer apparatus in the printing system according to the embodiment of the present invention;

FIG. 7 is a flowchart for explaining a print data generation process executed in the information processing apparatus according to a first embodiment of the present invention;

FIG. 8 is a flowchart showing details of an intermediate code generation process and a color attribute storage/save process for each page in step Si of FIG. 7;

FIG. 9 depicts a table for explaining an example of page index data according to the first embodiment;

FIG. 10 is a flowchart for explaining details of the first color determination process in step S19 of FIG. 8;

FIG. 11 depicts a view showing an example of the contents of a temporary intermediate code storage file created by the process executed in step Si of FIG. 7;

FIG. 12 is a flowchart for explaining generation of print data and the color processing mode designation process for each page in step S4 of FIG. 7;

FIG. 13 depicts a view for explaining a color processing mode designation command according to the first embodiment;

FIG. 14 is a flowchart for explaining details of the second color determination process in step S52 of FIG. 12;

FIG. 15 is a flowchart showing a process step added to FIG. 8 for explaining a print data generation process executed in an information processing apparatus according to a second embodiment of the present invention;

FIGS. 16A and 16B depict tables for explaining the relationship between a physical page and a logical page according to the second embodiment of the present invention;

FIG. 17 is a flowchart showing a step added to FIG. 12 for explaining the print data generation process executed in the information processing apparatus according to the second embodiment of the present invention; and

FIG. 18 is a flowchart showing steps added to FIG. 12 for explaining the print data generation process executed in the information processing apparatus according to the second embodiment of the present invention.

### DETAILED DESCRIPTION OF THE PREFERRED EMBODIMENTS

Preferred embodiments of the present invention will be described in detail below with reference to the accompanying drawings.

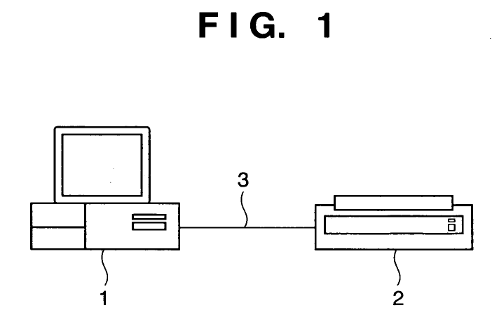

FIG. 1 is a block diagram for explaining the arrangement of a printing system which realizes a printing color processing mode according to an embodiment of the present invention.

In FIG. 1, an information processing apparatus 1 and printer 2 are connected by a Centronics interface cable 3. For descriptive convenience, the information processing apparatus 1 and printer 2 are connected in one-to-one correspondence. However, the present invention can be applied to a single device having the apparatus 1 and printer 2 or a system comprised of a plurality of devices connected directly or via a network such as a LAN or WAN as far as the functions of the present invention are executed.

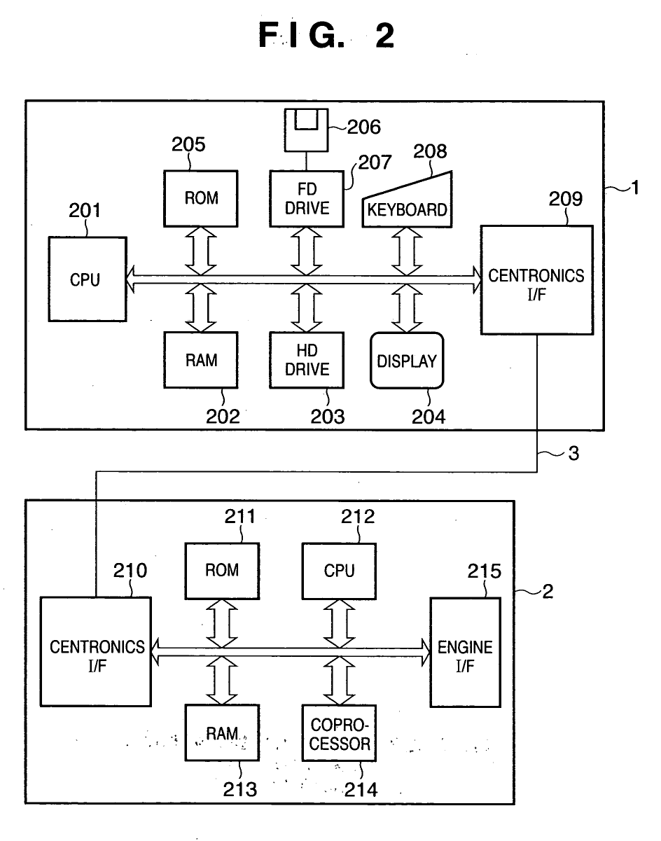

FIG. 2 is a block diagram for explaining the connection and arrangement of the information processing apparatus 1 and the printer 2.

The information processing apparatus 1 comprises a CPU 201 which controls each unit of the apparatus 1 and executes a program, a RAM 202 having a work area for executing an OS, application program, or the like, an HD drive 203 which stores an automatic printing color processing mode control program according to the embodiment, a display 204 which displays data, processing results, or the like, a ROM 205 which stores programs, fonts, and various data (e.g., template data), an FD 206 which stores a printer driver and the automatic color processing mode control program (to be described in the embodiment), an FD drive 207 which loads a program or data stored in the FD 206, a keyboard 208 including a pointing device (not shown) for input by user operation, and a Centronics interface 209 (host side). Printer drivers, various programs, and the like stored in the FD 206 are read by the FD drive 207 under the control of the CPU 201, and installed in the HD drive 203. In executing control operation by the CPU 201, the stored programs are read out from the HD drive 203 to the RAM 202 and executed.

The CPU 201 executes, for example, an outline font rasterization process to a display RAM set in the RAM 202, and enables WYSIWYG on the display 204 such as a CRT. The CPU 201 opens various registered windows and executes various data processes on the basis of commands designated with a mouse cursor (not shown) or the like on the display 204. When the user executes printing, he/she opens a print setting window to set an operation condition of a printer and set a print processing method to the printer driver that includes selection of a print mode.

The arrangement of the printer 2 will be explained.

A Centronics interface 210 (printer side) receives print data from the information processing apparatus 1 via the Centronics interface cable 3. A ROM 211 stores a control program such as a mode switching control program described later. A CPU 212 comprehensively controls each device on the basis of the control program stored in the ROM 211, and outputs an image signal serving as print data to a printer engine (not shown) via an engine interface 215. A RAM 213 functions as a main memory or work area for the CPU 212. A coprocessor 214 executes simple calculation in cooperation with the CPU 212. The engine interface 215 controls an interface with the printer engine (not shown) which conveys a print sheet and prints.

The printer 2 according to the embodiment comprises a full-color mode and monochrome mode as color processing modes. As will be described later, the printer 2 can switch the color processing mode for each page of print data on the basis of control information input from the information processing apparatus 1 serving as a host. The Centronics interface cable 3 can be replaced by a network. Even if the Centronics interfaces 209 and 210 are network interfaces or network boards, they can satisfy the embodiment.

The CPU 212 can communicate with the information processing apparatus 1 via the Centronics interface 210 serving as an input unit, and can notify the information processing apparatus 1 of information of the printer 2 or the like. The RAM 213 can expand its memory capacity by an optional RAM connected to an extension port (not shown). The RAM 213 is used as a print data mapping area, environment data storage area, NVRAM, or the like.

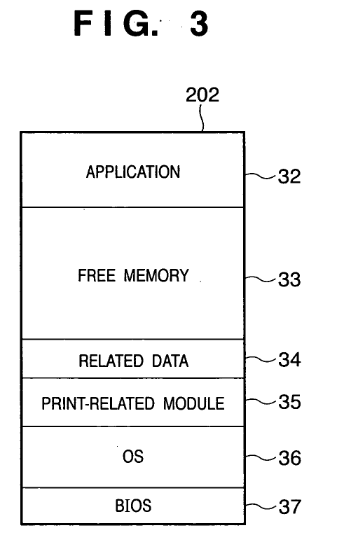

FIG. 3 depicts a view showing the memory map of the RAM 202 of the information processing apparatus 1 according to the embodiment. FIG. 3 illustrates the memory map in a state in which a print-related module containing the automatic printer color processing mode control program is loaded to the RAM 202 from the HD drive 203 in the information processing apparatus 1 and can be executed.

The memory map includes an area 32 where an application program is stored, a free memory 33, a related data area 34, a print-related module 35 containing the automatic printer color processing mode control program, an OS 36, and a BIOS 37.

The automatic color processing mode control program containing instructions executed in accordance with flowcharts.(to be described later) is stored as a print-related module containing the automatic printer color processing mode control program in the FD 206 or HD drive 203 of the information processing apparatus 1. The CPU 201 executes the program under the control of the OS 36. By executing the program, control processes shown in the flowcharts are executed.

According to the embodiment, in the information processing apparatus 1, a BIOS, OS, application, and print-related module containing the automatic printer color processing mode control program according to the embodiment are stored in the RAM 202, and executed by the CPU 201 to perform control operation (to be described later). The BIOS 37 is stored in the ROM 205, and the OS 36 is installed in the HD drive 203. When the information processing apparatus 1 is powered on, the OS 36 is loaded from the HD drive 203 to the RAM 202 by the IPL (Initial Program Loading) function of the BIOS program, starting the operation of the OS 36. In practice, the print-related module containing the automatic printer color processing mode control program can operate when a print process is executed by an application running under the control of the OS in the information processing apparatus 1 in accordance with an instruction from the user or the like, or when the FD 206 which stores the print-related module is set in the FD drive 207 or the print-related module has already been installed in the HD drive 203, and the print-related module is read out from the FD 206 or HD drive 203 and loaded to the RAM 202 under the control of the OS 36 and BIOS 37. As described above, FIG. 3 shows the memory map of the RAM 202 in a state in which the print-related module containing the automatic printer color processing mode control program according to the embodiment is loaded to the RAM 202 of the information processing apparatus 1 and can be executed.

The automatic printer color processing mode control program according to the embodiment may be stored in the HD drive 203 or ROM 205 of the information processing apparatus 1, or program codes may be installed from a storage medium such as the FD 206 via the FD drive 207, thereby implementing the function of the control program. The storage medium which stores the program is not limited to a floppy disk (FD), and may be a CD-ROM, CD-R, magnetooptical disk, optical disk, magnetic tape, nonvolatile memory, or the like. In this case, the program codes read out from the storage medium implement functions according to the embodiment, and the storage medium which stores the program codes constitutes the present invention.

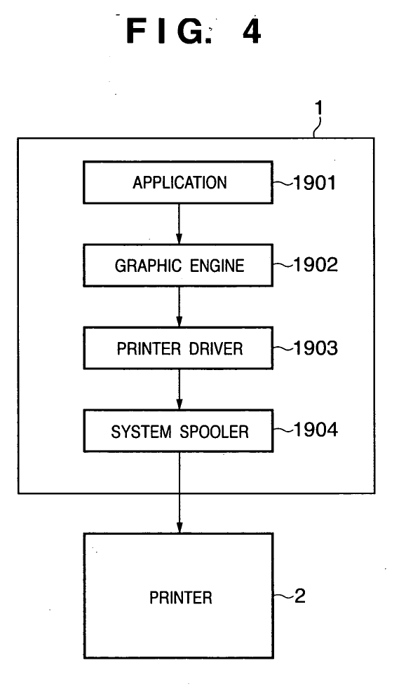

FIG. 4 is a block diagram for explaining the software configuration of the information processing apparatus 1 in the printing system in which the information processing apparatus 1 and printer 2 according to the embodiment are connected.

An application 1901, graphic engine 1902, printer driver 1903, and system spooler 1904 exist as files saved in the HD drive 203 serving as an external memory, and are program modules which are loaded in execution to the RAM 202 and then executed by the OS 36 or a module utilizing these modules, and then executes them. The application 1901 and printer driver 1903 can be added to the HD drive 203, the FD 206, a CD-ROM (not shown), or an external memory HD via a network (not shown).

The application 1901 saved in such external memory is loaded to the RAM 202 and executed. Upon printing using the printer 2 based on instructions of the application 1901, rendering is performed using the graphic engine 1902 which is similarly loaded to the RAM 202 and can be executed.

The graphic engine 1902 converts a print instruction into a control command for the printer 2 by using the printer driver 1903 prepared for each printer apparatus. The converted printer control command is supplied to the system spooler 1904 loaded to the RAM 202 by the OS 36 and then output to the printer 2 via the Centronics interface cable 3.

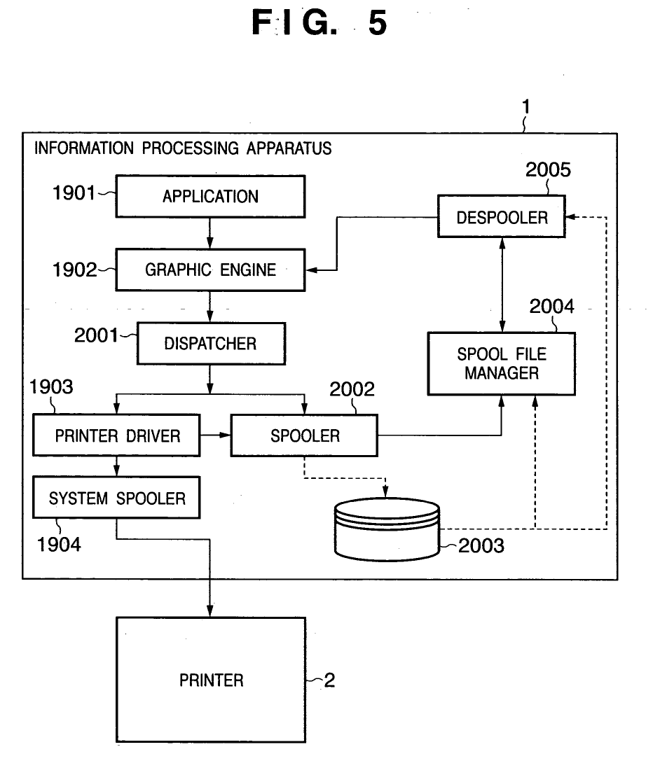

The printing system according to the embodiment may adopt an arrangement which temporarily spools a print command from an application as intermediate code data, as shown in FIG. 5, in addition to the printing system having the printer 2 and information processing apparatus 1 shown in FIG. 4.

FIG. 5 is a block diagram for explaining the software configuration of a printing system expanded from the printing system shown in FIG. 4. When a print instruction is sent from the graphic engine 1902 to the printer driver 1903, a spool file 2003 containing an intermediate code is temporarily generated. In FIG. 5, the same reference numerals as in FIG. 4 denote the same parts.

In the printing system of FIG. 4, the application 1901 is released from a print process when the printer driver 1903 converts all print instructions from the graphic engine 1902 into control commands for the printer 2. To the contrary, in the printing system of FIG. 5, the application 1901 is released from a print process when a spooler 2002 converts all print instructions into intermediate code data and the intermediate code data have been stored in the spool file 2003. The latter process generally takes a shorter time.

The printing system in FIG. 5 can process the contents of the spool file 2003. This can implement functions not given to the application 1901, such as scaling and printing of images of a plurality (n) of pages into one page (n-in−1 printing), in response to a print command from the application 1901. For these purposes, the system is so expanded as to spool a print instruction as intermediate code data. In order to process a print command, the process is generally set by the user using a UI window provided by the printer driver 1903, and the printer driver 1903 saves the setting contents in the RAM 202 or HD drive 203.

The printing system in FIG. 5 will be explained in detail. In the expanded processing system shown in FIG. 5, a print instruction from the graphic engine 1902 is received by a dispatcher 2001. When a print instruction received by the dispatcher 2001 from the graphic engine 1902 is a print instruction issued from the application 1901 to the graphic engine 1902, the dispatcher 2001 loads to the RAM 202 the spooler 2002 installed in the HD drive 203, and sends a print instruction not to the printer driver 1903 but to the spooler 2002.

The spooler 2002 converts the received print command into an intermediate code and stores the intermediate code in the spool file 2003. The spooler 2002 acquires various setting data associated with print data set in the printer driver 1903, from the printer driver 1903, and saves the setting data in the spool file 2003. The spool file 2003 is generated as a file in the HD drive 203, but may be generated in, e.g., the RAM 202. The spooler 2002 loads to the RAM 202 a spool file manager 2004 installed in the HD drive 203, and notifies the spool file manager 2004 of the generation status of the spool file 2003. The spool file manager 2004 determines whether printing is possible in accordance with the set contents of print process associated with print data that are stored in the spool file 2003.

When the spool file manager 2004 determines that printing is possible by using the graphic engine 1902, a despooler 2005 installed in the HD drive 203 is loaded to the RAM 202, and is instructed to perform a print process for the intermediate code stored in the spool file 2003. The despooler 2005 processes the intermediate code contained in the spool file 2003 in accordance with the contents of print process contained in the spool file 2003, and again outputs a print instruction via the graphic engine 1902 to the dispatcher 2001.

When a print instruction received from the graphic engine 1902 is a print instruction issued from the despooler 2005 to the graphic engine 1902, the dispatcher 2001 sends a print instruction not to the spooler 2002 but to the printer driver 1903. The printer driver 1903 generates a printer control command and outputs it to the printer 2 via the system spooler 1904. As a result, the printer 2 executes a print process corresponding to the print instruction.

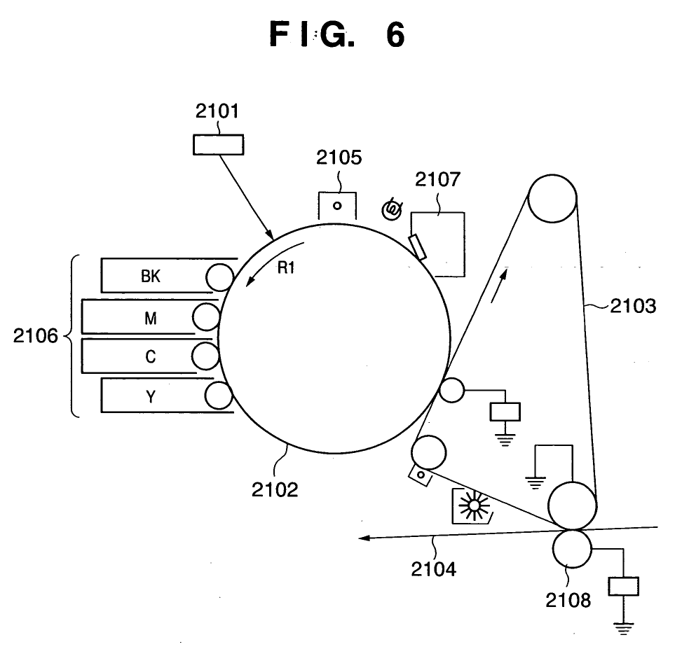

FIG. 6 depicts a sectional view for explaining the color printing mechanism of the printer 2 according to the embodiment. In this case, the printer 2 is an electrophotographic color laser beam printer, but the present invention is not limited to this and can also be applied to a printer of another printing method such as an inkjet printer.

In the printer 2, a laser beam is modulated in accordance with image data of each color that is obtained on the basis of print data supplied from the information processing apparatus 1. The laser beam is reflected by a polygon mirror 2101 to scan on a photosensitive drum 2102, forming an electrostatic latent image on the photosensitive drum 2102. The electrostatic latent image is developed with toners of corresponding color to obtain a visible color image. Visible images of all colors (Bk, M, C, and Y) are transferred onto a transfer belt 2103 serving as an intermediate transfer member to form a color visible image. The color visible image is transferred and fixed onto a transfer medium 2104 such as a printing sheet. An image printing section which performs this control comprises a drum unit having the photosensitive drum 2102, a primary charging unit 2105 having a contact charging roller, a cleaning unit 2107, a developing unit 2106, the intermediate transfer belt 2103, a paper feed unit including a sheet cassette and various rollers, a transfer unit including a transfer roller 2108, and a fixing unit (not shown). A detailed description of each arrangement in the image printing section is the same as that of a conventional electrophotographic color laser beam printer, and the description will be omitted.

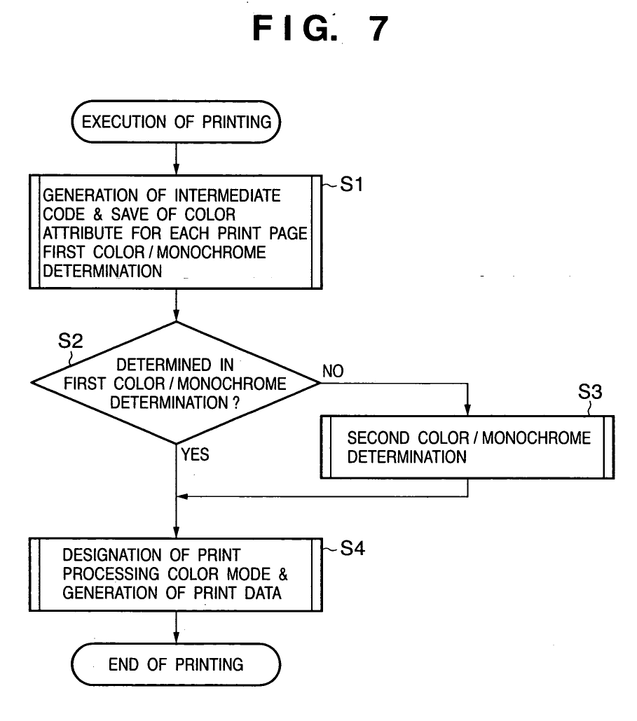

FIG. 7 is a flowchart for explaining a schematic process by the automatic printer color processing mode control program according to the embodiment. The program which executes this process is stored in the FD 206 or HD drive 203, loaded to the RAM 202, and executed under the control of the CPU 201.

When execution of a print process is designated, a print command (e.g., code data) received from the application 1901 is converted into an intermediate code and the intermediate code is temporarily stored in the HD drive 203 in step S1. The first color/monochrome determination is executed on the basis of color attribute information of each print command included in a print request from the application 1901, and the determination result is stored in the RAM 202. At this time, information representing color processing mode determined at step S1 is saved for each page. The flow advances to step S2 to determine whether the color processing mode information of each page stored in the RAM 202 is specified to be color or monochrome or is not specified (unknown). If a page whose color has not been determined exists in step S2, the flow advances to step S3 to perform the second color/monochrome determination for a rendering instruction (corresponding to 24-BPP image data in the embodiment) which has not undergone the first color/monochrome determination among the rendering instructions for the page. The determination result is stored in the RAM 202 at step S3, and the flow advances to step S4.

If YES in step S2 or after step S3 is executed, the flow advances to step S4. Print data to be transmitted to the printer 2 is generated and the color processing mode of each page is designated on the basis of the intermediate code temporarily saved in the HD drive 203 and the color processing mode information of each page which has been generated in step S1 or S3 and stored in the RAM 202.

In the embodiment, the intermediate data is generated from the print command, and the color attribute of the print command is determined by the CPU 201, but the present invention is not limited to this. In a conventional color printer having a plurality of color processing modes, a received print command changes depending on the color processing mode, and print data to be output to the printer 2 must be changed in accordance with the color processing mode. For this reason, in the embodiment, the intermediate data is generated so that the application 1901 can be not only quickly released from a print process but also the print command can be processed in order to accomplish functions in which the application 1901 and/or the printer 2 does not have.

The embodiment can also be implemented without generating intermediate data. For example, the color attribute of a print command may be determined by once analyzing code data serving as the print command by the CPU 201. After that, print data to be output to the printer 2 may be generated in accordance with the color attribute. The CPU 201 determines the color attribute before generating print data because the print data to be generated is depended on the color attribute of the print command, as described above. That is, if the print command only includes monochrome data, no color information is necessary, and it is sufficient that a flag representing the monochrome mode is set in the print data. When the color attribute of the print command represents “color”, a color flag is set in the print data (no monochrome flag may be set) because the print data including color information must be generated. In order to realize this process by a conventional printer, the color attribute must be determined before print data is generated.

However, if the printer 2 is a type of printer which can process the same type of print data independent from monochrome print mode and color print mode, color attribute information may be added to print data after the print data is generated and after then the print data may be transmitted to the printer 2.

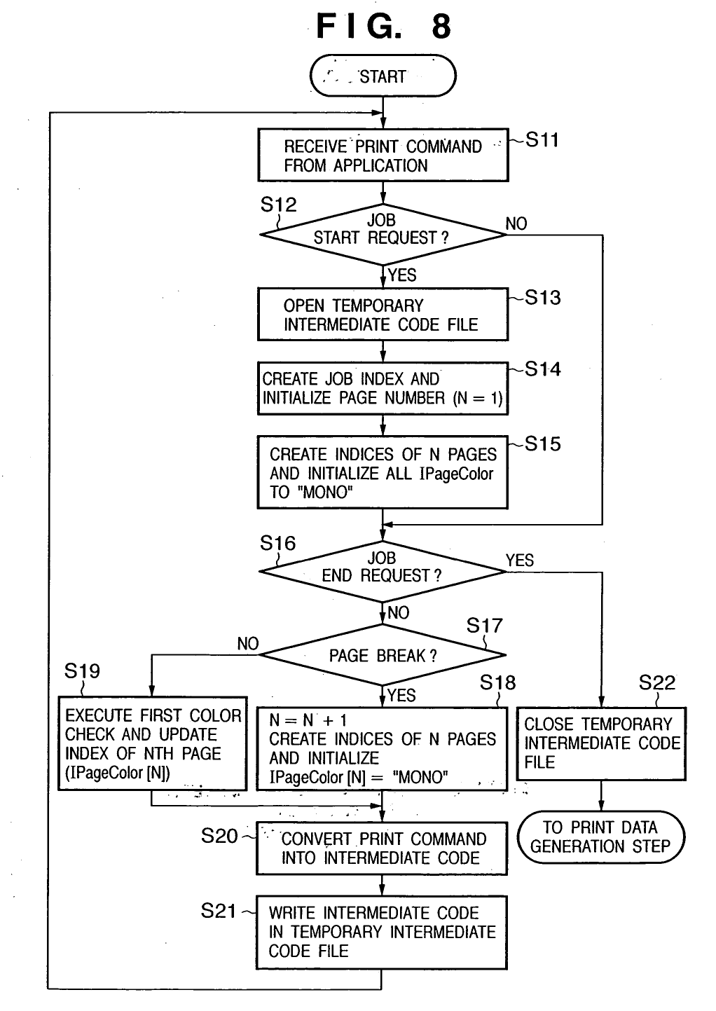

FIG. 8 is a flowchart showing details of the intermediate code generation process and the color attribute storage/save process for each page in step S1 of FIG. 7. In the embodiment, these processes are executed upon generating the spool file 2003 in the spooler 2002.

In step S11, a print command from the application 1901 is received. The flow advances to step S12 to determine whether the received print command is a print job start request. If the print command is determined to be a print job start request, the flow advances to step S13. The spool file 2003 serving as a temporary intermediate code storage file for temporarily saving intermediate data is created in the HD drive 203 of the information processing apparatus 1. An identifier for identifying the print job is added to the spool file, and the created spool file 2003 is opened.

The flow advances to step S14 to notify the spool file manager 2004 of the progress of the print process and the identifier for specifying the spool file 2003. A page number is initialized. The page number is used to refer color attribute information of the print command for each page. That is, the value of a page counter N representing the page number is reset to “1”. This means execution of a process for the first page of the print command.

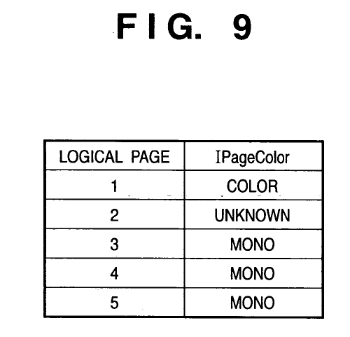

The flow advances to step S15 to create the indices of N pages in the related data area 34 (FIG. 3) in the RAM 202, and the indices of N pages are all initialized to “MONO” indicating a monochrome processing. As the related data, data of the Nth page is added to the end of a data area (table as shown in FIG. 9) for the data of (N−1)th page, as the page number is incremented. By this process, the printer driver 1903 can execute the first color/monochrome determination on the basis of color attribute information of each print command from the application 1901.

FIG. 9 depicts the table for explaining an example of correspondence between the page number and the color processing mode (IPageColor) according to a first embodiment of the present invention.

In FIG. 9, logical page 1 is color, pages 3 to 5 are monochrome, and page 2 is unknown (undetermined). The logical page indicates a page number of a printed image based on the print command.

If the received print command is not a print job start request in step S12 or after step S15 is executed, the flow advances to step S16 and it is determined whether the print command received in step S11 is a print job end request. If it is determined not to be the print job end request at step S16, the flow advances to step S17 to determine whether a page break is requested. If YES in step S17, the flow advances to step S18 to notify the spool file manager 2004 of the progress of the print process and the color processing mode. For example, for N=5, a page index shown in FIG. 9 is created. The page counter N is incremented (+1), and a page index corresponding to the updated page counter (N) is newly created at the end of the table as shown in FIG. 9, in the related data area 34 of the RAM 202. “Monochrome (MONO)” is then set in the IPageColor[N] portion as the default value of the color processing mode at the page index of the updated page (N).

In the spool file manager 2004, a color processing mode corresponding to each logical page is stored in the IPageColor[N] portion in the format of FIG. 9, and referred to in order to determine the color processing mode of each logical page by the spool file manager 2004, which will be described later.

If the print command from the application 1901 is determined in step S17 not to be a page break, the flow advances to step S19 to perform the first color/monochrome determination. The first color/monochrome determination does not take a long processing time, and the color processing mode (IPageColor[N]) of the page index of a corresponding page (N page) as shown in FIG. 9 is updated in accordance with the color attribute information in the print command. For example, if the color processing mode set for the first page before updating is “monochrome (MONO)” and the color attribute of a function which designates character drawing is a single color (e.g., in Windows2002/XP^{TR}, BLUSHOBJ in DrvTextOut is a solid color (SolidColor)), the single color is set. As a result of setting, the color attribute (IPageColor[N]) is changed to a full color “COLOR” from “MONO”. When the function which designates rendering is an image rendering function (e.g., in Windows2002/XP^{TR}, SURFOBJ in DrvCopyBits, DrvStrechBlt, . . . ), all pixel values of an image must be determined for accurate color determination. If, however, the page contains a large-size monochrome image, the determination takes a long time. Thus, in the first color/monochrome determination, the image rendering function is not examined. The image data size is referred to before the determination, and if the size exceeds a predetermined size, the image rendering function is not examined. When the page does not have any chromatic color attribute information to the end of the page, the monochrome mode (MONO) is kept set as the default value. When the page contains color image data which takes a long time for checking all items of the image data, the color attribute is determined to be unknown (“UNKNOWN”) without examining whole data of the page.

In the first embodiment, in a case where it is determined in the first color/monochrome determination that the page contains a print command surely having one full-color attribute, the color processing mode of the page is set to “full color (“COLOR”)”, and data of pages succeeding the page are not checked.

After step S18 or S19 is executed, the flow advances to step S20 to convert the print command into a corresponding intermediate code. The flow then advances to step S21 to write the intermediate code in the temporary intermediate code file in the HD drive 203. Thereafter, the flow returns to step S11 again to receive a print command from the application 1901 again. A series of processes from step S11 to step S21 continue until the job end request is received from the application 1901 in step S11 and determined in step S16.

If the print command from the application 1901 is determined in step S16 to be the print job end request, all print command from the application 1901 have been processed. The flow advances to step S22 to notify the spool file manager 2004 of the progress of the print process and close the spool file 2003. The process advances to a step of generating print data and designating the printing control method.

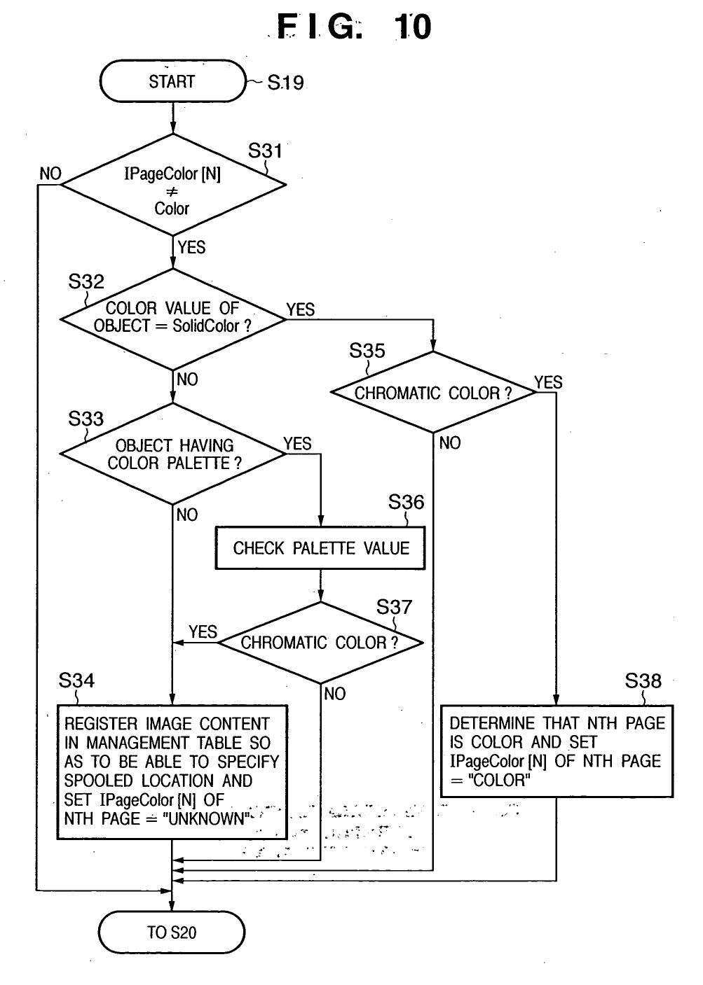

FIG. 10 is a flowchart for explaining details of the process in step S19 of FIG. 8.

In step S31, it is determined whether the color processing mode (IPageColor[N]) of a logical page of interest is set to the color mode (COLOR). If it is determined as the color mode, the process directly advances to step S20. If it is not determined to be the color mode, the flow advances to step S32 to determine whether the color parameter of a print object of the page is an immediate value (SolidColor). If YES in step S32, the flow advances to step S35 to determine whether the immediate value represents a chromatic color. If the immediate value does not represent any chromatic color, the process ends and the flow advances to step S20. If the immediate value represents a color, the flow advances to step S38 to set the color processing mode (IPageColor[N]) of the page (N) to “full color (COLOR)”. The process then ends and advances to step S20.

If the color parameter of the print object of the page is not immediate value (SolidColor) in step S32, the flow advances to step S33 to determine whether the print object is the print command having a color palette. If NO in step S33, the flow advances to step S34 to spool the print command which contains data such as image data, in which it takes a long time for checking details of the data. The spooled command is registered in a management table (stored in the related data area 34) so as to be able to determine which print command is spooled. The color processing mode (IPageColor[N]) of the page (N) is set to unknown (“UNKNOWN”). The process ends and the flow advances to step S20.

If the print command has a color palette in step S33, the flow advances to step S36 to check color information of the color palette. The flow advances to step S37 to determine whether the color palette has a chromatic color. If the color palette does not have any chromatic color, the process ends and the flow advances to step S20. If the color palette has a chromatic color, the flow advances to step S34 to execute the above-described process.

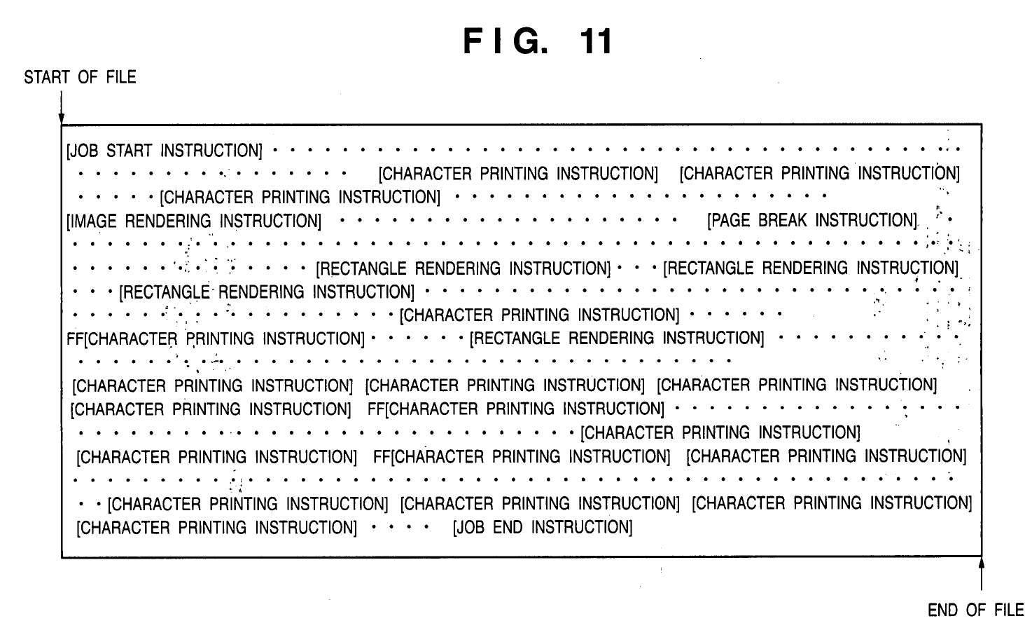

FIG. 11 depicts a view showing an example of the contents of the temporary file of intermediate code data in the HD drive 203 in step S1 of FIG. 7, i.e., by generation of an intermediate code and the process of saving the color processing mode for each page. In FIG. 11, a “job start instruction”, “page break instruction” (FF), “character printing instruction”, and the like are described. They are expressions for easy understanding of print data in the file, and are stored in the binary format in practice.

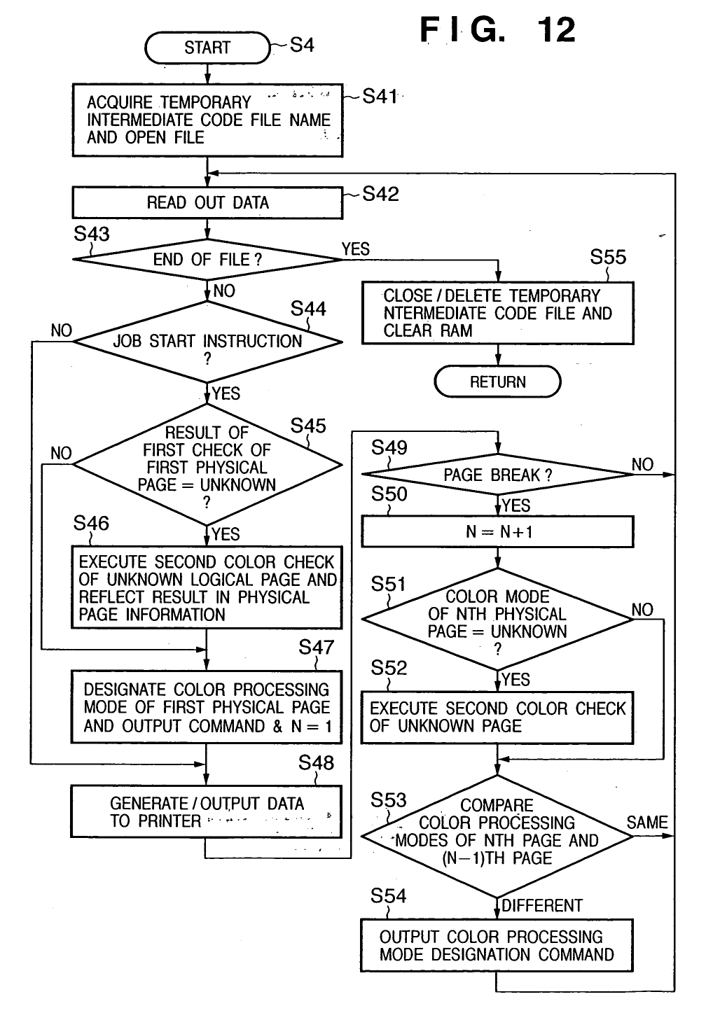

FIG. 12 is a flowchart for explaining print data generation and the color processing mode designation process for each page in steps S3 and S4 of FIG. 7.

In step S41, the temporary intermediate code file stored in the HD drive 203 is opened. As described above, the contents of the temporary intermediate code file have, e.g., the structure shown in FIG. 11. The flow advances to step S42 to start searching for the intermediate code of the print command. In step S42, the intermediate data is read out in response to each print command as shown in FIG. 11. In the example of FIG. 11, an intermediate code which is first read out is a “job start instruction”. The intermediate codes are sequentially read out, and the process continues until a “job end instruction” is read out at last.

In step S43, it is determined whether the intermediate code is a “job end instruction” indicating the file end. If the intermediate code is the file end, the flow advances to step S55; if NO, to step S44 to determine whether the intermediate code is a “job start instruction”. If the intermediate code is determined to be a “job start instruction”, the flow advances to step S45 to check the color processing mode of the first page by referring to the page index (IPageColor) as shown in FIG. 9. A color processing mode (IPageColor[0]) as a result of the first color/monochrome determination of the first page is checked to determine whether the color processing mode is “unknown (UNKNOWN)”. If the color processing mode of the page is unknown, the flow advances to step S46 to sequentially check the image rendering function (image data) of the page, in which a color of page has not been checked in detail in the first color/monochrome determination (second color/monochrome determination). If even one color data exists in the page, the color processing mode of the page is changed to “full color (COLOR)” and “full color (COLOR)” is set in the color processing mode (IPageColor[N]). If no color data exists, the color processing mode (IPageColor[N]) of the page is changed to “monochrome (MONO)” from “UNKNOWN”.

In the second color/monochrome determination, it is determined whether R, G, and B values designated by the image rendering function of the page are “0,0,0” (black) or “255,255,255” (white: corresponding to values for a 24-BPP image). If the R, G, and B values take only these values, the image of the page is determined to be a monochrome one. If even one pixel having another value exists, the image of the page is determined to be a color one.

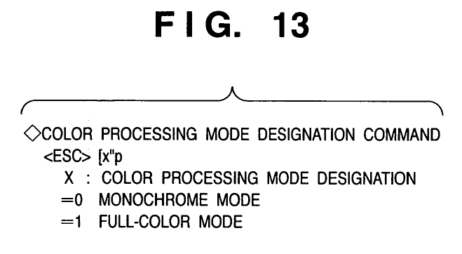

If the color processing mode of the page is known in step S45 or after step S46 has been executed, the flow advances to step S47 to create a command to designate the color processing mode of the page in a data format as shown in FIG. 13. Further, a variable N for holding page information during the processing is initialized to “1”. In this way, the color processing mode designation command for designating the color processing mode is set at the head of print data to be output to the printer 2. This facilitates processes in the printer 2.

FIG. 13 depicts a view for explaining the color processing mode designation command.

In FIG. 9, for example, the color processing mode of the first page is “full color (COLOR)”, and command “<ESC>[1“p” (see FIG. 13) is set to the head of the print data to be output to the printer 2.

If it is determined in step S44 that the intermediate code is not to be a “job start instruction”, or after step S47 has been executed, the flow advances to step S48. Print data is generated on the basis of intermediate data read out from the temporary intermediate code file in the HD drive 203, and output to the printer 2. The flow advances to step S49 to determine whether the command read out in step S42 is a “page break instruction”. If the command does not designate any page break, the flow returns to step S42 to execute the above-mentioned process.

If the readout data is the page break instruction in step S49, print data representing the page break is output to the printer 2. The flow advances to step S50 to increment the variable N representing a page number during processing and forward the page number. This makes the loading page and page position information always correspond to each other. The flow advances to step S51 to check the color processing mode (IPageColor) of the page serving as a result of the first color/monochrome determination of the Nth page and it is determined whether the color processing mode of the page is “unknown (UNKNOWN)”. If the color processing mode is known as “full color (COLOR)” or “monochrome (MONO)”, the flow advances to step S53. If the color processing mode is unknown, the flow advances to step S52 to sequentially check, in accordance with the management table, the intermediate code or image data of the Nth page which has not been checked in detail in the first color/monochrome determination, i.e., whose color processing mode is unknown. If even one color data exists, the color processing mode (IPageColor[N]) of the page is changed to “full color (COLOR)” from unknown “UNKNOWN”. If no color data exists, the color processing mode (IPageColor[N]) of the page is changed to “monochrome (MONO)” from unknown “UNKNOWN”.

If the color processing mode is known in step S51 or after the process in step S52 is executed, the flow advances to step S53. The color processing mode of a page (N−1) before incrementing the variable N by which the number of pages is counted and the color processing mode of the page (N) after increment are compared to determine whether these color processing modes are different from each other. If the color processing modes are determined to be different, the flow advances to step S54. The color processing mode designation command to designate the color processing mode is created in the data format shown in FIG. 13 in accordance with the color processing mode of the page (N) after increment of N, and output to the printer 2. The flow returns to step S42 to execute the above-described process. If the color processing modes of the pages are determined in the comparison process of step S53 to be the same, no color processing mode need be designated, and the process directly returns to step S42 to execute the above process.

For example, in the example shown in FIG. 9, the print data are a total of five pages. As a result of the first color/monochrome determination, the color processing mode is “full color (COLOR)” for the first page, (UNKNOWN) for the second page, and “monochrome (MONO)” for the third and following pages. In this case, a full-color mode designation command is issued for the first page, and the color processing mode of the second page is determined by the second color/monochrome determination process. If the color processing mode is resultantly determined to be “color”, a full-color of color processing mode designation command is issued immediately after reception of the page break instruction for the second page.

In step S43, a “job end instruction” or the like is identified, and if the file end is determined, data representing the end of the job is output to the printer 2, and the flow advances to step S55. In step S55, the temporary intermediate code file in the HD drive 203 is closed and deleted, and all pieces of information such as the variable N representing the page number are erased from the RAM 202, ending the process. Hence, no intermediate data or the like remains in the information processing apparatus 1 after print data has been transferred to the printer 2.

As described above, FIG. 9 shows an example of color processing mode information of print data for each page generated in the related data area 34 of the RAM 202 by the step (step S1) of generating an intermediate code, storing a color attribute, and saving it for each page in FIG. 7.

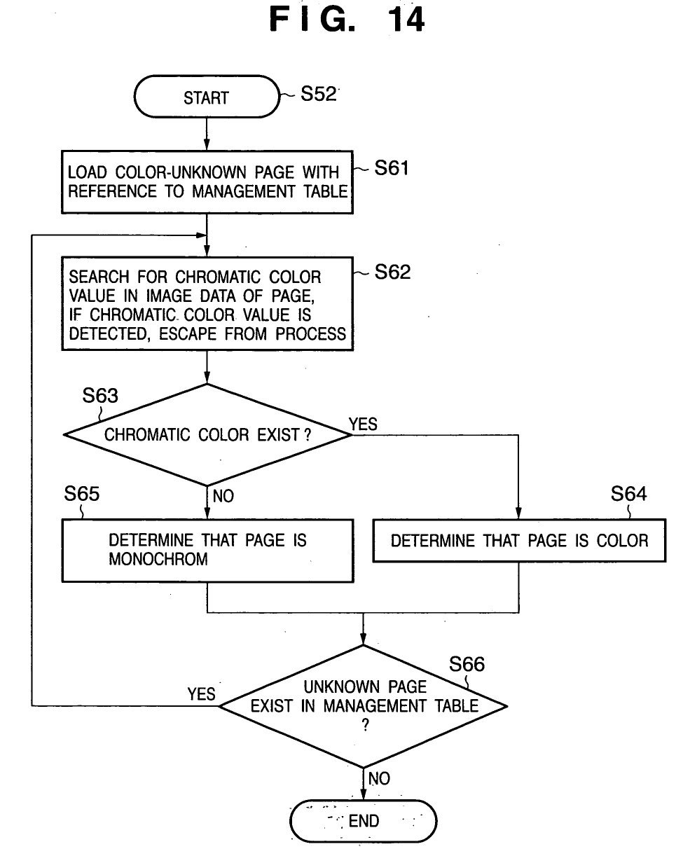

The second color/monochrome determination process executed in step S52 of FIG. 12 will be explained with reference to the flowchart of FIG. 14.

In step S61 of FIG. 14, a page whose color processing mode is “unknown (UNKNOWN)” is checked from, e.g., the page indices shown in FIG. 9. In step S62, the intermediate code and image data of the page are read out, and data of the page are sequentially examined to determine whether even one chromatic color data exists. If even one chromatic color data exists in the page, the flow advances to step S64 to change the color processing mode (IPageColor[N]) of the page to “full color (COLOR)” from “UNKNOWN”. The process then advances to step S66.

If no chromatic color data exists in step S63, the flow advances to step S65 to change the color processing mode of the page to “monochrome (MONO)” from “UNKNOWN”. The flow advances to step S66 to determine whether the index table still holds a page whose color processing mode is “unknown (UNKNOWN)”. If such page exists, the page is set as a target page, and the flow advances to step S62 to execute the above-described processes. In this fashion, the color processing mode of the page whose color processing mode is “unknown (UNKNOWN)” can be determined.

The automatic color processing mode control program according to the first embodiment can be stored in the ROM 205 singly or as a print-related module containing the automatic color processing mode control program. The program can be formed as a part of the memory map in FIG. 3, and directly executed by the CPU 201.

According to the first embodiment, in a case where it is determined the color processing mode of print data for each page by the information processing apparatus 1, a page which can be easily determined to be color can be determined to be color at high speed, realizing high-speed, high-precision color/monochrome determination.

### Second Embodiment

The second embodiment of the present invention will be described. According to the second embodiment, a print-related module running in the information processing apparatus 1 or a print module running in the printer 2 in the first embodiment has a function (n-in-one printing function) of reducing a plurality of print pages (logical pages) and laying them out on one page (physical page). The second embodiment will describe a process when a print process is executed by an application running under the control of the OS in the information processing apparatus 1 and printing using the n-in−1 printing function is designated. The arrangements and basic operations of the information processing apparatus 1 and printer 2 according to the second embodiment are the same as those in the first embodiment, and a description thereof will be omitted.

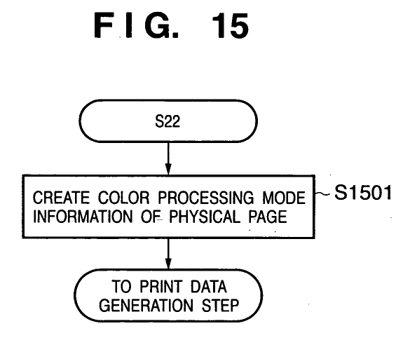

FIG. 15 is a flowchart for explaining a process according to the second embodiment of the present invention. This process is executed subsequent to step S22 of FIG. 8.

For example, printing of two pages is designated by an application 1901, and a print command for print data of eight pages is issued. In this case, one physical page contains four pages (4-in−1 printing) in order to print data of eight pages into two page.

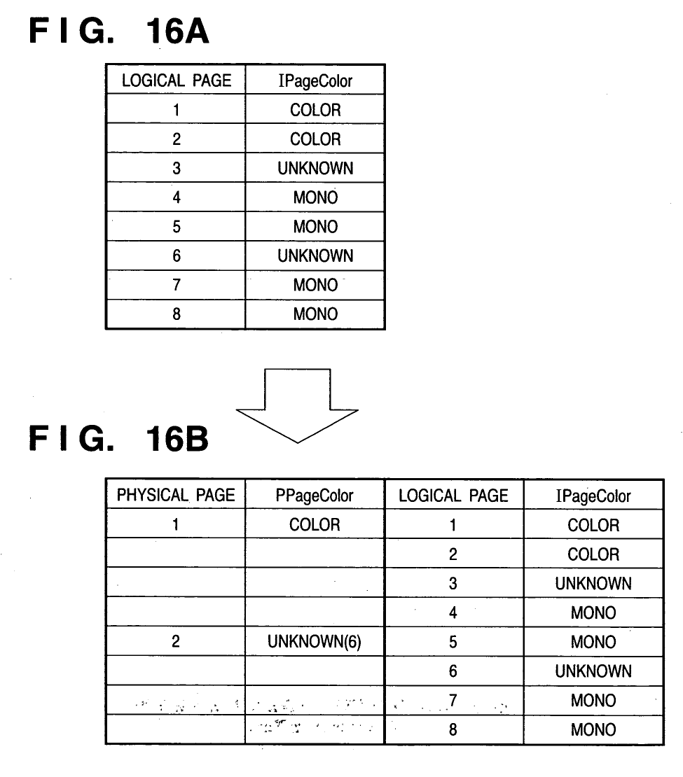

FIGS. 16A and 16B depict tables for explaining the status of print data of each page.

As shown in FIG. 16A, the color processing modes of the logical pages of eight pages are stored. The process advances to step S1501 of FIG. 15. As shown in FIG. 16B, the color processing mode of each physical page is generated from color attribute information stored in the related data area 34 of the RAM 202, and stored in the RAM 202. In the second embodiment, four logical pages form one physical page, as described above. In the example shown in FIGS. 16A and 16B, of logical pages 1 to 4 contained in physical page 1, the color processing modes of logical pages 1 and 2 are “full color (COLOR)”, and the color processing mode of physical page 1 is determined to be “full color”. Of logical pages 5 to 8 contained in physical page 2, logical pages 5, 7, and 8 are “monochrome (MONO)” and page 6 is “unknown (UNKNOWN)”. In this case, only unknown page 6 undergoes the above-mentioned second color/monochrome determination. As a result, if page 6 is determined to be monochrome, the color processing mode of physical page 2 is determined to be “monochrome (MONO)”; if page 6 is determined to be color, to be “full color (COLOR)”. High-precision color determination can be achieved with a small processing load. After step S1501 has been completed, the print data generation process shown in the flowchart of FIG. 12 is executed.

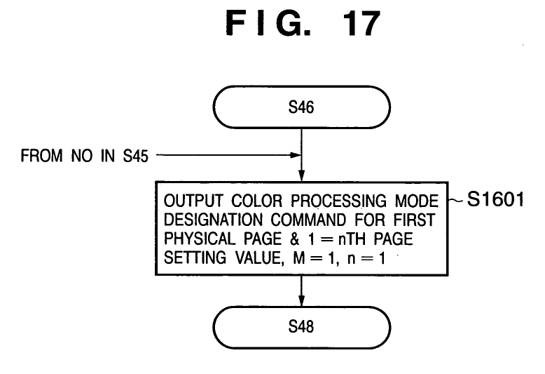

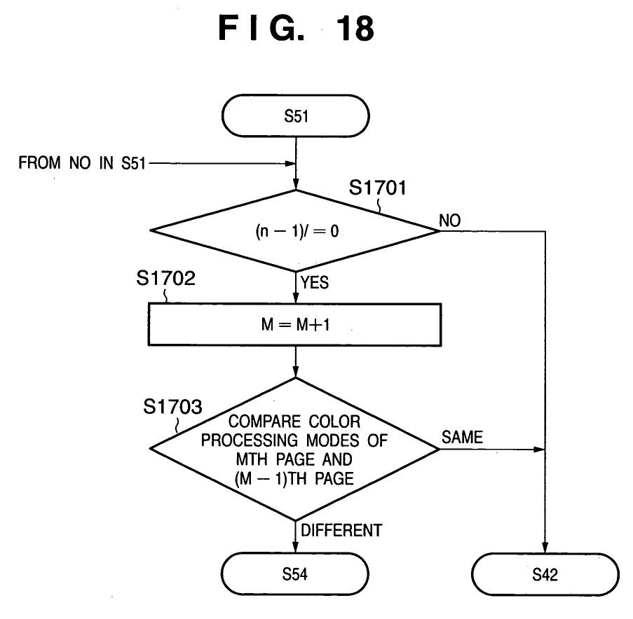

The flowcharts of FIGS. 17 and 18 show processes according to the second embodiment which are added to the processing flowchart (FIG. 12) according to the first embodiment.

The print data generation process is basically the same as that in the first embodiment. In the page reduction mode, three processes are changed. First, as shown in FIG. 17, the flow advances to a process in step S1601 of FIG. 17, instead of the process in step S47 of FIG. 12. In step S1601, the color processing mode of the first physical page shown in FIGS. 16A and 16B is referred to. Print command is created in the command format shown in FIG. 13 and output to the printer 2. The print setting value of the n-th page during processing, the physical page counter, and the logical page counter are initialized.

Second, as shown in FIG. 18, processes in steps S1701 to S1703 are executed in place of the process in step S53 of FIG. 12. More specifically, in step S1701, it is determined whether print data under creating process is the first page of logical page. If the print data is the first logical page, this means a new physical page, and the flow advances to step S1702. If NO in step S1701, this means the print data is included in the previous physical page under creating, and the flow advances to step S42.

In step S1702, print data representing the page break is generated and output to the printer 2. The counter (M) which counts the number of physical pages is incremented (+1) and made to correspond to an actually printed page. The flow advances to step S1703 to compare the color processing mode of a physical page (M) whose print data is being created and that of an immediately preceding physical page (M−1). These color processing modes are stored in the RAM 202. If they coincide with each other, no color processing mode need be changed, and the flow advances to step S42. If they are determined to be different, the flow advances to step S54 in order to output a color processing mode designation command to change the color processing mode. The subsequent process is the same as that in FIG. 12.

Third, even if the page break command is determined in step S49 of FIG. 12, generation of print data representing the page break and output to the printer 2 are not performed, and the determination is performed in step S1701.

According to the second embodiment, when so-called (n-in−1) printing of printing print data of a plurality of (n) pages on one paper sheet is executed, the processes shown in FIGS. 17 and 18 are added to the processes in the first embodiment. A color processing designation command can be created for each physical page to print without outputting a color processing mode designation command for each logical page. The second embodiment can avoid contradictory designation of a plurality of color processing modes for a single physical page. Print data of n pages can be printed on one paper sheet at high speed in an optimal color processing mode.

As described above, the second embodiment can perform high-precision color/monochrome determination at high speed.

According to another invention, high-precision color/monochrome determination can be achieved by the minimum check process even if n-page printing is designated.

### Other Embodiment

As described above, the object of the present invention is also achieved when a storage medium which stores software program codes for realizing the functions of the above-described embodiments is supplied to a system or apparatus, and the computer (or the CPU or MPU) of the system or apparatus reads out and executes the program codes stored in the storage medium. In this case, the program codes read out from the storage medium realize the functions of the above-described embodiments, and the storage medium which stores the program codes constitutes the present invention. The storage medium for supplying the program codes includes a floppy® disk, hard disk, optical disk, magnetooptical disk, CD-ROM, CD-R, magnetic tape, nonvolatile memory card, and ROM.

The functions of the above-described embodiments are realized when the computer executes the readout program codes. Also, the functions of the above-described embodiments are realized when an OS (Operating System) or the like running on the computer performs some or all of actual processes on the basis of the instructions of the program codes.

Furthermore, the present invention includes a case in which, after the program codes read out from the storage medium are written in the memory of a function expansion board inserted into the computer or the memory of a function expansion unit connected to the computer, the CPU of the function expansion board or function expansion unit performs some or all of actual processes on the basis of the instructions of the program codes and thereby realizes the functions of the above-described embodiments.

The present invention is not limited to the above embodiments and various changes and modifications can be made within the spirit and scope of the present invention. Therefore, to apprise the public of the scope of the present invention, the following claims are made.

What is claimed is:

1. A printing control apparatus comprising:
spool means for spooling a rendering object as intermediate data for each page;
first color processing mode determination means for determining a color processing mode of each page on the basis of a color attribute of each page of the rendering object;
second color processing mode determination means for determining, on the basis of whether or not the intermediate data spooled in said spool means contains color data, the color processing mode of a page whose color processing mode cannot be determined by said first color processing mode determination means; and
transfer means for transferring, to a printing apparatus, print data which is generated from the intermediate data on the basis of the color processing mode determined by said first and/or second color processing mode determination means.

2. The apparatus according to claim 1, wherein
said first color processing mode determination means sets a page containing color data to a color mode, a page containing no color data to a monochrome mode, and a page, for which it cannot be determined whether or not it contains color data, to an unknown mode, and
said second color processing mode determination means determines the color processing mode by determining whether or not the color data is contained in all intermediate data of the page set as the unknown mode.

3. The apparatus according to claim 1, wherein said first color processing mode determination means checks only a single color value or a color value of a color palette in a rendering object of each page, in a case where the single color value contains a chromatic color, determines that the page has a color mode and ends check of the page,
in a case where image data in which the color palette contains a chromatic color or image data formed by a color value exists, determines that the page has an unknown mode and determines that the page has a monochrome mode for another page.

4. The apparatus according to claim 1, wherein said second color processing mode determination means sequentially checks intermediate data of one page determined to have an unknown mode, when color data is detected, determines that the page has a color mode, and when no color data is contained as a result of checking all intermediate data of the page, determines that the page has a monochrome mode.

5. The apparatus according to claim 1, wherein
said spool means spools the rendering object as intermediate data of each logical page,
said first color processing mode determination means determines the color processing mode of the logical page for the rendering object, and
in a case where a plurality of logical pages are reduced to a physical page and printed, said second color processing mode determination means determines the color processing mode of the physical page.

6. A printing control method comprising:
a spool step of spooling a rendering object as intermediate data for each page;
a first color processing mode determination step of determining a color processing mode of each page on the basis of a color attribute of the page of the rendering object;
a second color processing mode determination step of determining, on the basis of whether or not the intermediate data spooled in said spool step contains color data, the color processing mode of a page whose color processing mode cannot be determined in said first color processing mode determination step; and
a transfer step of transferring, to a printing apparatus, print data which is generated from the intermediate data on the basis of the color processing mode determined in said first and/or second color processing mode determination step.

7. The method according to claim 6, wherein
in said first color processing mode determination step, a page containing color data is set to a color mode, a page containing no color data-is set to a monochrome mode, and a page, for which it cannot be determined whether it contains color data is set, to an unknown mode, and
in said second color processing mode determination step, the color processing mode is determined by determining whether or not the color data is contained in all intermediate data of the page set to the unknown mode.

8. The method according to claim 6, wherein in said first color processing mode determination step, only a single color value or a color value of a color palette in a rendering object of each page is checked, in a case where the single color value contains a chromatic color, the page is determined to have a color mode and check of the page is ended,
in a case where image data in which the color palette contains a chromatic color or image data formed by a color value exists, the page is determined to have an unknown mode, and another page is determined to have a monochrome mode.

9. The method according to claim 6, wherein in said second color processing mode determination step, intermediate data of one page determined to have an unknown mode are sequentially checked, when color data is detected in the page, the page is determined to have a color mode, and when no color data is contained as a result of checking all data of the page, the page is determined to have a monochrome mode.

10. The method according to claim 6, wherein
in said spool step, the rendering object is spooled as intermediate data of each logical page,
in said first color processing mode determination step, the color processing mode of the logical page is determined for the rendering object, and
in said second color processing mode determination step, when a plurality of logical pages are reduced to a physical page and printed, the color processing mode of the physical page is determined.
